(19) United States
(12) Patent Application Publication
(10) Pub. No.: US 2016/0308356 A1
(43) Pub. Date: Oct. 20, 2016

(54) Method and Apparatus for Electrical Distribution Grid Control

(71) Applicant: ABB Technology AG, Zurich (CH)

(72) Inventors: Debrup Das, Fremont, CA (US); Joseph Carr, Raleigh, NC (US); Martin Knabenhans, Nussbaumen (CH)

(21) Appl. No.: 14/688,900

(22) Filed: Apr. 16, 2015

(51) Int. Cl. H02J 3/00; G05B 13/02

(52) U.S. Cl. CPC H02J 3/00; G05B 13/026

(57) ABSTRACT

According to one aspect of the teachings herein, a controller communicatively couples to and advantageously exploits a distributed control network of an industrial plant by, for example, using information received over the distributed control network to predict the value of one or more electrical parameters of an electrical distribution grid of the industrial plant, and to generate and transmit converter control commands based on the predicted value(s). These converter control commands target one or more converters located within the electrical distribution grid, each converter having an Active Front End or AFE that allows the reactive power consumption of the converter to be adjusted via the converter control commands.

### TECHNICAL FIELD

The present invention generally relates to electrical networks, and particularly relates to controlling an electrical distribution grid.

### BACKGROUND

Power-electronic converters find increasing use in electric power distribution networks. While converter architectures vary, a general class of converters may be regarded as having a “network side” facing the distribution network or grid and a “load side” facing the load(s). The network side of the converter may consist of various semi-conductor based switches. Where the network side of the converter consists of one or more controllable switches, the converter is said to have an “active front end” or AFE. Examples of controllable semi-conductor switches include IGBT, MOSFET, etc., while examples of uncontrollable semi-conductor switches include diodes.

Hence a converter can be either have a “diode front end” or an AFE. The power-electronic switches of the AFE enable control of the network-side voltage or reactive power of the converter at the network node, where the converter is connected to the network. Example converters that may be implemented with AFEs include AC-to-DC converters and AC-to-DC-to-AC converters, such as may be used for powering and controlling industrial drives within a factory or other industrial distribution network.

### SUMMARY

According to one aspect of the teachings herein, a controller communicatively couples to and advantageously exploits a distributed control network of an industrial plant by, for example, using information received over the distributed control network to predict the value of one or more electrical parameters of an electrical distribution grid of the industrial plant, and to generate and transmit converter control commands based on the predicted value(s). These converter control commands target one or more converters located within the electrical distribution grid, each converter having an Active Front End or AFE that allows the reactive power consumption of the converter to be adjusted via the converter control commands.

In an example embodiment, a controller is configured to control an electrical distribution grid used to power an industrial plant that includes one or more converters each having an AFE that is controllable to adjust reactive power consumption by the converter. The controller includes a network interface configured to communicatively couple the controller to a distributed control network of the industrial plant, according to one or more network communication protocols used by the distributed control network, and further includes a processing circuit that is operatively associated with the network interface.

The processing circuit is configured to obtain a predicted value for an electrical parameter of the electrical distribution grid, where the predicted value is based on at least one of historical data compiled for the electrical distribution grid and process control information for the industrial plant incoming to the controller from the distributed control network. Further, the controller is configured to determine first reactive-power consumption adjustments for a first targeted one or more of the converters, based on evaluating the predicted value for the electrical parameter. The controller is further configured to generate first converter control commands for the first targeted one or more of the converters, based on the first reactive-power consumption adjustments, and transmit the first converter control commands to the first targeted one or more converters.

In another embodiment, a method adjusts the reactive power consumption by one or more converters in an electrical distribution grid that is used to power an industrial plant, where each converter includes an AFE that is controllable by the converter, for adjusting the reactive power consumption of the converter. Within this framework, the method includes obtaining a predicted value for an electrical parameter of the electrical distribution grid, where the predicted value is based on at least one of historical data compiled for the electrical distribution grid and process control information for the industrial plant incoming to the controller from a distributed control network. The method further includes determining first reactive-power consumption adjustments for a first targeted one or more of the converters, based on evaluating the predicted value for the electrical parameter, generating first converter control commands for the first targeted one or more of the converters, based on the first reactive-power consumption adjustments, and transmitting the first converter control commands to the first targeted one or more converters.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a block diagram of one embodiment of a controller configured to control one or more converters in an electrical distribution grid used to power loads in an industrial plant.

FIG. 2 is a logic flow diagram of one embodiment of a method of controlling one or more converters in an electrical distribution grid.

FIG. 3 is a block diagram of a typical set of loads associated with an industrial plant process.

FIGS. 4-7 are block diagrams of processing modules and associated process and electrical model information, such as used by a digital processor or other processing circuit, to build models for predicting process and electrical states, and to control converters and/or other AFEs in an electrical distribution grid based on predicting process and electrical states.

FIG. 8 is a diagram of example performance provided by the prediction-based converter control according to the teachings herein, shown in comparison with certain conventional solutions, such as capacitor bank based compensation with switching threshold control.

### DETAILED DESCRIPTION

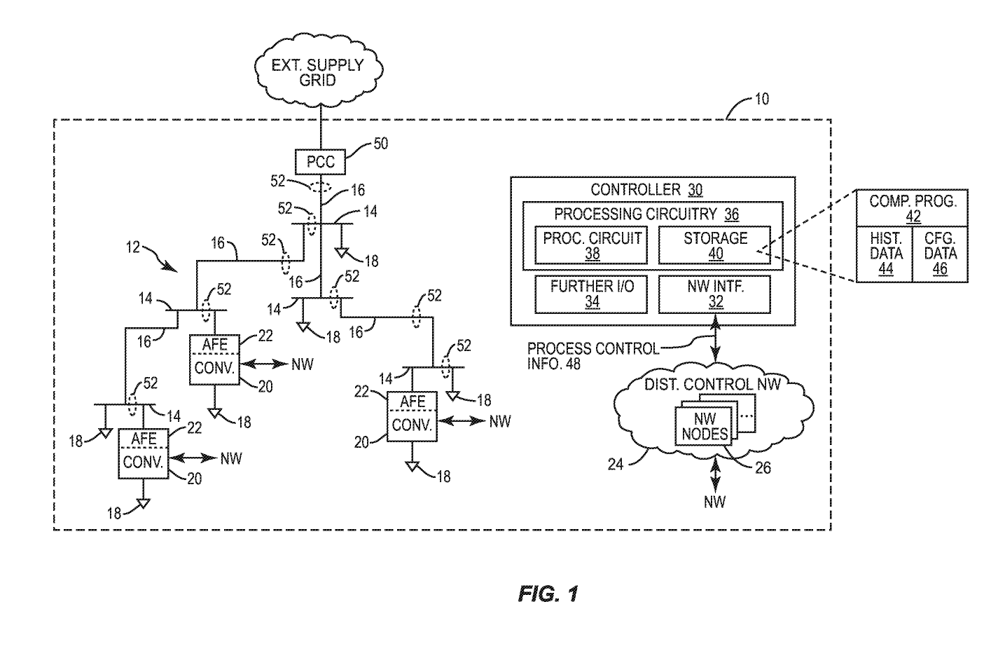

FIG. 1 illustrates an industrial plant 10 powered by an electrical distribution grid 12 comprising a number of buses 14 and interconnecting branch circuits 16. Various electrical loads 18 receive electrical power via the electrical distribution grid 12. In particular, converters 20 power some number of the loads 18. Note that use of common reference numbers “18” and “20” here does not mean that all of the electrical loads 18 are the same, nor that all of the converters 20 are the same. Some loads 18 may be for lighting, some may be associated with process control operations in the plant 10, and others may be associated with miscellaneous sundry loads in the plant 10. Similarly, a given converter 20 may be a variable-speed AC-AC drive, while another one may be an AC-DC drive, etc.

However, for purposes of this discussion, each of the converters 20 of interest includes an “Active Front End” or “AFE” 22, which enables an external controller to alter the real and/or reactive power consumption of the converter 20 by inputting converter control commands—set point values—to the converter 20. Each converter 20 is therefore shown with input/output signaling denoted as “NW” or network signaling, to represent the communicative coupling of each converter 20 to a distributed control network 24 that comprises any number of network nodes 26. Each network node 26 comprises a server computer system or other networked apparatus—such as any of a control device, monitoring device or storage device—that is configured for operation in the distributed control network 24.

Of particular interest, one sees a controller 30 comprising a network interface 32, further or additional input/output circuitry 34, and processing circuitry 36. The network interface 32 includes physical layer interface circuitry and protocol processing circuitry, configuring the controller to communicate with any one or more of the network nodes 26 of the distributed control network 24, via one or more network communication protocols. The further input/output, “I/O”, circuitry 34 may comprise analog I/O, digital I/O, or any mix thereof, including any mix of discrete signal inputs and data signaling inputs, whether parallel or serial.

The processing circuitry 36 comprises digital processing circuitry, such as microprocessor-based circuitry, Digital Signal Processing, DSP, circuitry, Field Programmable Gate Array, FPGA, circuitry, Application Specific Integrated Circuits, ASICs, or any mix thereof. However implemented, the processing circuitry 36 includes a processing circuit 38 that is configured to carry out the controller operations taught herein. The processing circuit 38 in some embodiments is functionally realized in the processing circuitry 36, based on the execution of program instructions. For example, the processing circuitry 36 includes or has access to one or more types of non-transitory computer-readable media—generally denoted as “storage” 40.

In some embodiments, the storage 40 stores a computer program 42, the execution of which at least partly implements the processing circuit 38 of interest herein. The storage 40 in one or more example embodiments further stores historical data 44 and/or configuration data 46, which separately or together are used for the predictive control disclosed herein for the controller 30. By way of non-limiting example, the storage 40 comprises any one or any mix of volatile and non-volatile memory, such as SRAM, DRAM, EEPROM, FLASH, and a Solid State Disk or SSD. Note that “non-transitory” as used herein with respect to the storage 40 does not necessarily mean permanent or unchanging storage, but does connote storage of at least some persistence, such as program memory for long-term storage of computer program instructions or configuration data, or working memory for temporary storage of working data and/or computer program instructions for execution.

Regardless of its implementation details, the controller 30 is configured to control the electrical distribution grid 12, which is, as noted, used to power the industrial plant 10. Of particular interest, the electrical distribution grid 12 includes one or more converters 20, with each converter 20 each having an active front end, AFE 22, that is controllable to adapt reactive power consumption by the converter 20.

The example controller 30 comprises the aforementioned network interface 32, which is configured to communicatively couple the controller 30 to the distributed control network 24 of the industrial plant 10, according to one or more network communication protocols used by the distributed control network 24. The processing circuit 38 is operatively associated with the network interface 32 and configured to obtain a predicted value for an electrical parameter of the electrical distribution grid 12. The predicted value is based on at least one of historical data 44 compiled for the electrical distribution grid 12 and process control information 48 for the industrial plant 10 incoming to the controller 30 from the distributed control network 24.

The processing circuit 38 is further configured to determine first reactive-power consumption adjustments for a first targeted one or more of the converters 20, based on evaluating the predicted value for the electrical parameter. Correspondingly, the processing circuit 38 is configured to generate first converter control commands for the first targeted one or more of the converters 20, based on the first reactive-power consumption adjustments, and to transmit the first converter control commands to the first targeted one or more converters 20.

With respect to the functionality described immediately above, it shall be understood that the prediction processing is not limited to a single parameter or to a single prediction. That is, the processing operation of obtaining a predicted value for an electrical parameter of the electrical distribution grid 12 may comprise obtaining multiple predicted bus voltages, e.g., for all or a selected buses 14 in the electrical distribution grid 12. Further, obtaining a predicted value for an electrical parameter of the electrical distribution grid 12 may comprise obtaining multiple predictions for more than one type of electrical parameter—e.g., predicted bus voltages, predicted branch currents, predicted voltage balances, predicted power consumptions, etc. The term “obtaining” as used in this regard shall be understood in at least some embodiments as performing the actual prediction operation, such as predicting the electrical parameter value based on historical data, past observations, etc.

Further, it shall be understood that the word “first” as used in the above example is merely a label of convenience. As such, the “first reactive-power consumption adjustments” may be understood as a label or term of reference for identifying particular ones among any number of ongoing converter control commands that are generated and output from the controller 30 over time. Likewise, the “first targeted one or more of the converters 20” may be understood as a label or term of reference for referring to the particular converter or converters 20 particularly targeted by the “first reactive-power consumption adjustments.” The first targeted converters 20 may comprise all of the converters 20 in the electrical distribution grid 12, a subset of them, or one of them. Moreover, with the understanding that the controller 30 performs ongoing control, e.g., periodically and/or on-demand or as needed, it will be understood that the particular converter or converters 20 targeted by the controller 30 may change over time—e.g., from one control instance to the next. As a further example, process control information incoming to the controller may implicate a particular one or more of the converters 20 in the electrical distribution grid 12, e.g., based on a known electrical architecture of the grid and/or mapping information known to the controller 30.

In at least one embodiment, the process control information 48 indicates a forthcoming electrical load change for the electrical distribution grid 12. To accommodate this type of data input, the processing circuit 38 is configured to predict the predicted value of the electrical parameter based on the forthcoming electrical load change. For example, the process control information 48 indicates that a particular load will be turned on or off, or otherwise changed at a particular time in the future. The timing may be indicated via a timestamp, where the controller 30 and the distributed control network 10 have a common time base, e.g., a GPS-based timing reference. In other embodiments, the timing may be indicated in time units, and the configuration data 46 includes information indicating to the controller 30 the actual time represented by each time unit.

In at least one embodiment of the controller 30, the process control information 48 indicates the forthcoming electrical load change by indicating a forthcoming process control action for the industrial plant 10. For example, the process control information 48 comprises a process identifier or other indicator. Correspondingly, the processing circuit 38 is configured to determine the forthcoming electrical load change by accessing stored data that indicates a change in electrical load known or expected for the forthcoming process control action. For example, the configuration data 46 includes load values or other electrical parameter information that is mapped to or indexed by process control actions. In a non-limiting implementation, there may be a process identifier or more generalized process type indicator that maps to given motor sizes or given ranges of electrical loads, and the controller 38 therefore uses such information to predict how the operating state of the electrical distribution grid 12 will change as a consequence of the process control action(s) to be undertaken.

In the same or other embodiments, the processing circuit 38 is configured to determine the first reactive-power consumption adjustments for the first targeted one or more of the converters 20, to account for the forthcoming electrical load change, and to synchronize implementation of the first converter control commands at the first targeted one or more of the converters 20 with a timing of the forthcoming electrical load change. In other words, the controller 30 knows or determines the timing of the forthcoming process control actions, as indicated in the process control information 48, and synchronizes the converter adjustments its makes accordingly. In one example, the controller 30 controls the targeted converters 20 so that their reactive-power consumption adjustments are implemented coincident with the process control actions. In another example, the controller 30 controls the targeted converters 20 so that their reactive-power consumption adjustments are implemented in advance of the process control actions, e.g., as a preparatory operation or pre-compensation.

Broadly, given process control information incoming to the controller 30 indicates a process control action being undertaken, or to be undertaken, in the industrial plant 10. Correspondingly, the processing circuit 38 predicts the value of an electrical parameter—of the electrical distribution grid 12—with respect to the indicated process control action according to the historic data 44. Again, it will be appreciated that multiple parameter values may be predicted for different locations in the electrical distribution grid 12 and it will be appreciated that more than one type of parameter—power, voltage, current, etc.—may be predicted. In any case, the processing circuit 38 correlates previously measured values of the electrical parameter(s) being predicted, or previously measured values related to the electrical parameter(s) being predicted, with previously received process control information 48 indicating a same or similar process control action.

With respect to this operation and with respect to other capabilities of the controller 30, it will be appreciated that a number of sensors or measurement devices 52 may be distributed within the electrical distribution grid 12, for measuring various electrical parameters of the electrical distribution grid 12. The measurement devices 52 may interface with the controller 30 via the distributed control network 24 and/or may interface with the controller 30 via the further I/O circuitry 34 of the controller 30. Additionally, as a general proposition, each converter 20 includes local sensors or measurement devices, for measuring real and/or reactive power and voltage and current, at the converter's input and output. Thus, converter-specific data indicating the operating state or condition of each converter 20 at any given instant is generally available to the controller 30, e.g., via the distributed control network 24.

Continuing in the context of control based on historic data 44, the processing circuit 38 in some embodiments is configured to compile the historical data 44 by correlating previously observed changes in one or more electrical parameters of the electrical distribution grid 12 with at least one of: process control actions in the industrial plant 10, as indicated to the controller 30 via the network interface 32, and any of time of day, day of week and calendar date. For example, over time, the controller 30 may learn that a step change in electrical loading on a given first bus 14 of the electrical distribution grid 12 always occurs within a given window of time after a step change in electrical loading on a given second bus 14 of the electrical distribution grid 12. Further, the controller 30 may profile or trend overall loading or specific bus loading of the electrical distribution grid 12 as a function of time of day, day of week, date, etc.

For example, in one or more embodiments, the historical data 44 indicates that a certain electrical load change is expected at a certain time. The processing circuit 38 is configured to synchronize implementation of the first converter control commands at the first targeted one or more of the converters 20 with that certain time.

More generally, it will also be appreciated that the controller 30 in some embodiments is configured to perform ongoing control of the electrical distribution grid 12 responsive to receiving measured electrical parameters for the electrical distribution grid 12. In a particular example, the controller 30 is configured to perform an optimization process, for ongoing optimization of the electrical distribution grid 12 in terms of any one or more of: a total reactive power consumption of the electrical distribution grid 12, a voltage profile of the electrical distribution grid 12, and a transient voltage response of the electrical distribution grid 12.

In such embodiments, the controller 30 is configured to control the optimization process based on the measured electrical parameters, where, based on the optimization process, the controller 30 is configured to generate and send real or reactive power set points for one or more of the converters 20. For example, in at least one such embodiment, the processing circuit 38 is configured to perform ongoing control of the electrical distribution grid 12 responsive to receiving measured electrical parameters for the electrical distribution grid 12, based on being configured to generate second converter control commands for a second targeted one or more of the converters 20 in the electrical distribution grid 12. These second converter control commands are generated based on the measured electrical parameters, and they comprise one or both of reactive power set points and real power set points.

These “second” converter control commands may be distinct from the “first” converter control commands described above, or may be intermixed therein. For example, in performing ongoing control, the controller 30 may send periodic or triggered converter control commands to any one or more of the converters 20, where those commands are generated based on predicted changes or ongoing optimization, or a mix of both. In a further aspect of this predictive and/or ongoing control, the processing circuit 38 is configured to dynamically switch one or more individual ones of the one or more converters 20 between real-power control and reactive-power control. That is, one or more of the converters 20 is configured to perform autonomous localized control of its operating state so as to maintain or control one or both of the reactive and real power consumption at its input. At least with respect to reactive power, each converter 20 may be a net consumer or a net provider of reactive power, and thus provides the controller 30 with a mechanism for adjusting electrical conditions in the electrical distribution grid 12.

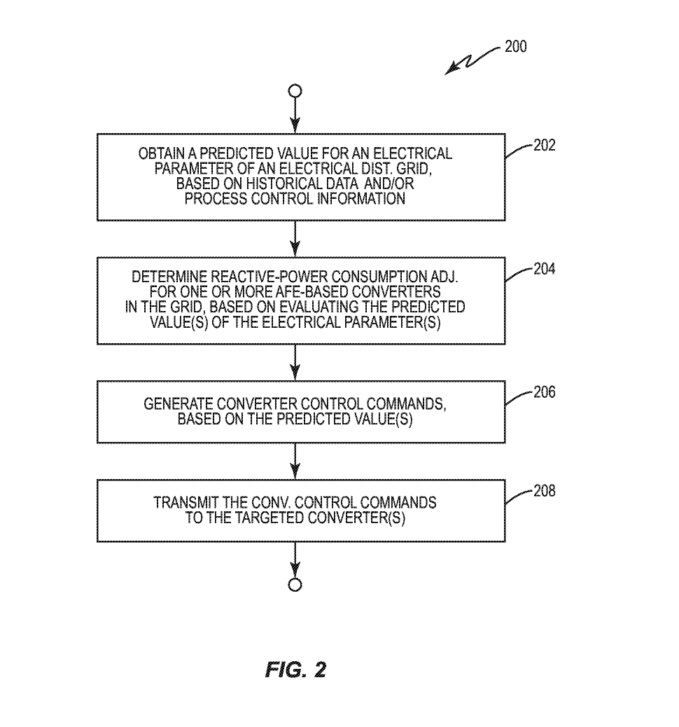

FIG. 2 illustrates one embodiment of a method 200 of controlling an electrical distribution grid 12 used to power an industrial plant 10 that includes one or more converters 20 each having an AFE that is controllable to adjust reactive power consumption by the converter 20. The example method 200 is, for example, carried out by a controller 30 and includes obtaining (Block 200) a predicted value for an electrical parameter of the electrical distribution grid 12, where the predicted value is based on historical data 44 compiled for the electrical distribution grid 12 and/or process control information for the industrial plant 10 incoming to the controller 30 from a distributed control network 24.

The method 200 further includes determining (Block 204) first reactive-power consumption adjustments for a first targeted one or more of the converters 20, based on evaluating the predicted value for the electrical parameter, generating (Block 206) first converter control commands for the first targeted one or more of the converters 20, based on the first reactive-power consumption adjustments, and transmitting (Block 208) the first converter control commands to the first targeted one or more converters 20. It will be appreciated that the method 200 may be performed on a periodic and/or triggered basis.

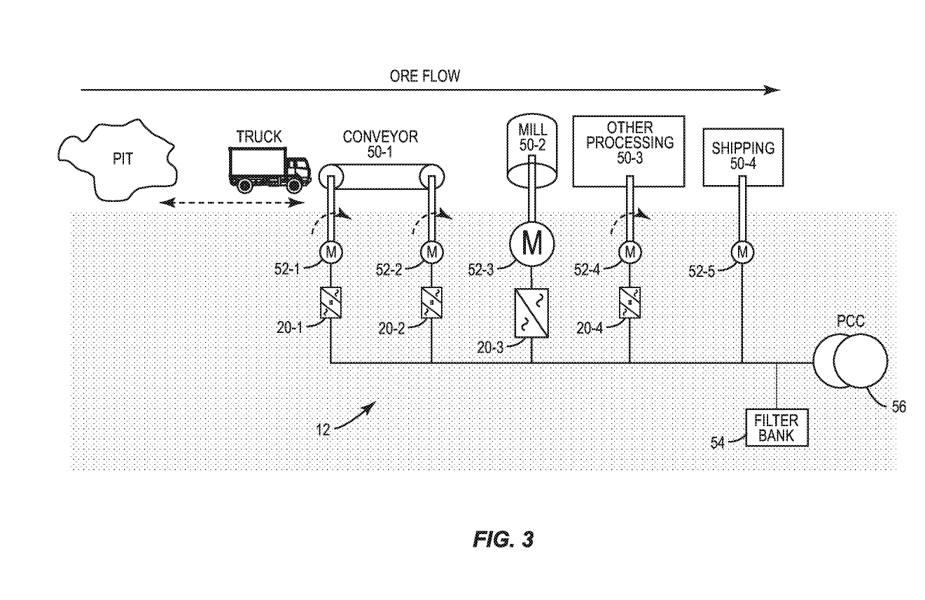

FIG. 3 illustrates an example scenario implicating one or both of historical information and process control information, as a basis for predicting the values of one or more electrical parameters of the electrical distribution grid 12. In particular, FIG. 3 depicts a generalized “flow” of operations for an ore mining operation, where ore is moved or processed by various items of plant equipment 50 that is driven by corresponding motors 52, at least some of which are associated converters 20 having AFEs allowing for reactive-power consumption adjustments at the converters 20. One also sees that the further compensating equipment may be available, such as a filter bank 54 coupled to the electrical grid 12, which is supplied, for example, by an external transmission network (not shown) through a Point of Common Coupling or PCC 56.

Suffixes, e.g., “-1,” “-2,” and so on are used to differentiate between different items or types of plant equipment, motors, and converters. With that in mind, trucks move ore excavated from a pit to a conveyer 50-1 that in turn conveys the raw ore to initial mill processing equipment 50-2. The truck-based supplying of ore to the conveyor 50-1 suggests that the conveyor 50-1 may experience sudden load increases, e.g., as loads are repeatedly dumped onto or removed from the conveyor 50-1. Correspondingly, the motors 52-1 and 52-2 experience potentially dramatic changes in loading, implying dynamically changing demands on the affected controllers 20-1 and 20-2.

The controller 30 may monitor the motors 52-1, 52-2 and 52-3 and/or the corresponding controllers 20-1, 20-2 and 20-3, to accumulate historical data reflecting the timing and extent of loading variations and can use that historical data to predict corresponding values in the electrical grid 12, e.g., voltages, currents, etc., and to generate compensating reactive-power adjustment commands for the converters 20-1, 20-2 and 20-3, which are respectively associated with the motors 52-1, 52-2 and 52-3 that drive the conveyor 50-1 and the initial processing equipment 50-2. The same “batch” based processing may flow through to other processing equipment 50-3, etc.

Additionally, or alternatively, the controller 30 receives process control information from the distributed control network 24 that indicates when the conveyor 50-1 is or will be loaded or offloaded, and/or when various ones of the other items of processing equipment 50 will be activated. The controller 30 may also derive further information, such as by knowing how long the equipment 50-2 will process a load of ore before the processed ore is passed along to the other processing equipment 50-3. Thus, by knowing when given equipment is activated and by knowing the duration of that equipment's processing, the controller 30 can accurate predict when one or more items of downstream equipment will become active. Further, it may be provided with other metrics, such as material volume, weight, etc., from which it can make more sophisticated predictions of the voltages and currents associated with equipment activations and deactivations.

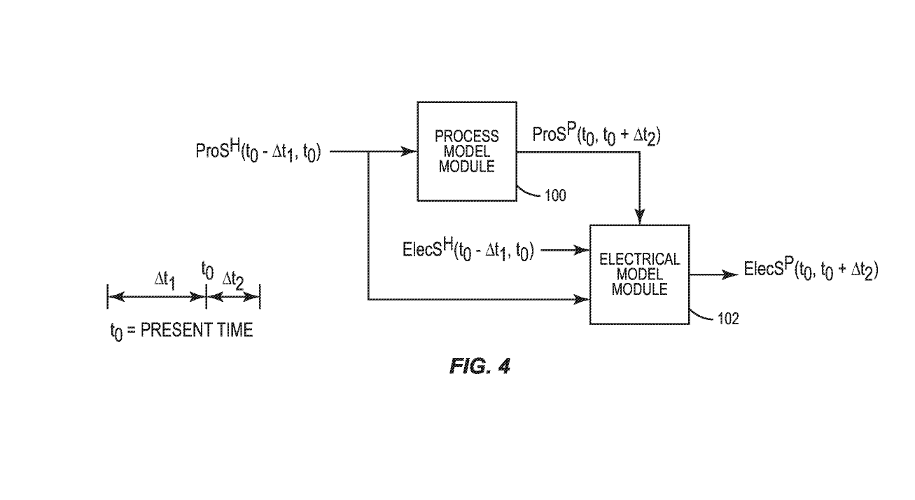

With these possibilities in mind, FIG. 4 depicts an example predictive control operation of the controller 30 to obtain the one or more electrical value predictions on which reactive power consumption adjustments for one or more of the converters 20 are determined. Here, the controller 30 and/or other elements within the processing circuitry 36 implement a process model module 100 and an electrical model module 102. These modules 100 and 102 are operative to take as inputs measured process states (ProcS^{H}) for the industrial plant 10, and measured electrical states (ElecS^{H}) for the electrical distribution grid 12, and use them to predict corresponding future process states(ProcS^{P}) and future electrical states (ElecS^{P}). In the foregoing expressions, the “H” superscript denotes historical measured values.

Examples of process states can be seen with reference back to FIG. 3, and may include the location of the truck, the weight of the ore on the conveyer belt, and whether or not the mill is active or about to become active. Examples of electrical states for the electrical distribution grid 12 can also be referenced to FIG. 3, and may include the voltage at various electrical buses, power consumption by the AFEs seen in the controllers 20 driving the various motors 52, and reactive power measurements on various buses. The controller 30 obtains the process data via the network interface 32, for example, as seen in FIG. 1, and may similarly obtain the electrical data via the network interface 32 and/or through other signaling connections to various electrical sensors positioned within the electrical distribution grid 12.

The measured process and electrical states are taken over an interval of time, Δt₁, that has occurred in the immediate past of the present time, t₀, and therefore represents historical data. The predicted states cover a future time interval, Δt₂. These time intervals may be as short as a single point in time, or may encompass a series of points in time. Depending upon the nature of the industrial processes in play, these points in time may correspond to fractions of a second, seconds, minutes, hours, days, etc. Moreover, not all variables are necessarily updated on the same time scale. For example, a short-term variable may be updated at a first rate, while a longer-term variable is updated at second, slower rate.

The measured historical process states, ProS^{H}(t₀−Δt₁, t₀) are fed into the process model module 100, which has information about the relationship between the historical process states and the future process states. As such, the process model module 100 produces a set of predicted process states over the future time interval, ProS^{P} (t₀, t₀+Δt₂). These predicted future process states ProS^{P} (t₀, t₀+Δt₂) are fed into the electrical model module 102, along with the measured historical process and electrical states ProS^{H}(t₀−Δt₁, t₀) and ElecS^{H} (t₀−Δt₁, t₀).

This electrical model module 102 has information about the relationship between these historical process and electrical states and the future electrical states, as well as between the predicted process states and the future electrical states. Thus, the electrical model module 102 uses the measured (historical) process and electrical states ProS^{H}(t₀−Δt₁, t₀) and ElecS^{H}(t₀−Δt₁, t₀), and the predicted process states ProS^{P} (t₀, t₀+Δt₂), to produce the corresponding predicted future electrical states ElecS^{P} (t₀, t₀+Δt₂) for the same time period(s).

The involved process and state models may contain relationships between all of possible inputs and outputs, or between one or more subsets of the inputs and outputs, because some process and electrical states may not influence each other. The models may also be able to make an adequate prediction using less input data than is available, so the process model module 100 and/or the electrical model module 102 may be configured to use a subset of the available data. Such configurations may relax memory requirements and/or lower processing complexity.

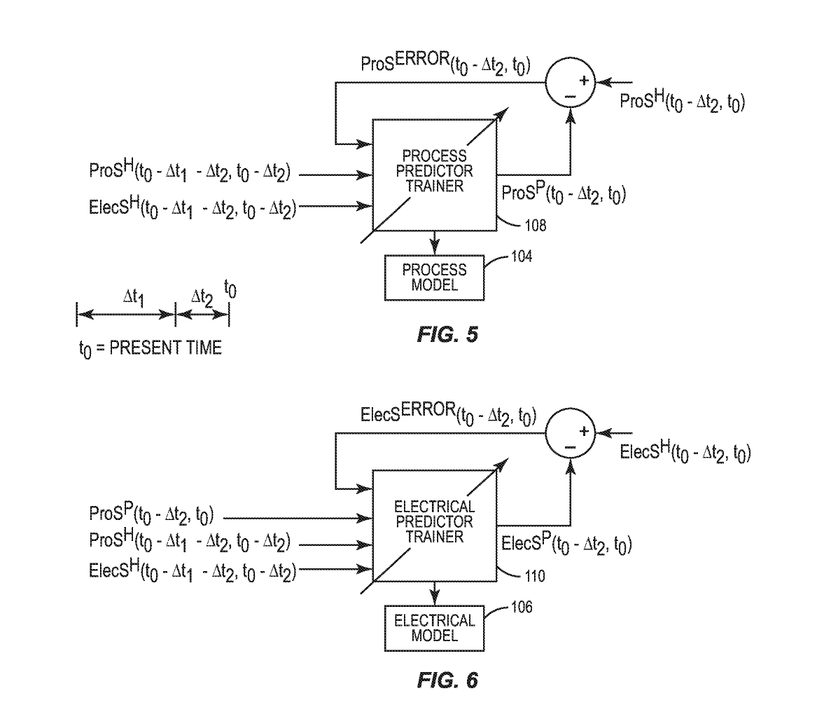

FIGS. 5 and 6 illustrate training operations for generating a process model 104 and an electrical model 106. The process model 104 is used by the process model module 100 of FIG. 4 to make process state predictions, and the electrical model 106 is used by the electrical model module 102 of FIG. 4 to make electrical state predictions. More particularly, FIG. 5 depicts a process predictor trainer 108 configured to build the process model 104 and FIG. 6 depicts an electrical predictor trainer 110 configured to build the electrical model 106.

The trainers 108 and 110 are, for example, functional circuits implemented via fixed or programmed circuitry within the processing circuitry 36 of the controller 30. The process model 104 and the electrical model 106 comprise databases or other stored data structures that map or otherwise associate input states (measured historical states) to output states (predicted or future states). The models 104 and 106 may capture these input-to-output state relationships by way of look-up tables and/or by evaluating continuous or non-continuous functions.

The trainers 108 and 110 in one embodiment use machine-learning techniques to build the process and electrical models 104 and 106, such as particle swarm optimization and neural networks. Through these machine-learning techniques, the trainers 108 and 110 learn the relationship between the measured historical process and electrical states and the future electrical states.

For example, the process predictor trainer 108 receives training sets of process and electrical states ProS^{H}(t₀−Δt₁−Δt₂, t₀−Δt₂) and ElecS^{H}(t₀−Δt₁−Δt₂, t₀−Δt₂), along with a set of test process state data ProS^{H}(t₀−Δt₂, t₀), all of which are taken from historical measurements of the process and electrical states in the industrial process to be controlled. Note that the time intervals Otₜ and Otₜ correspond to the historical measurement time interval and future prediction time interval used in the prediction operation exemplified in FIG. 4. This use of consistent intervals and corresponding training data is to ensure that the resulting training corresponds to the “real” system that the process and electrical models are expected to predict.

The process predictor trainer 108 uses an initialized or starting version of the process model 104 to produce a set of predicted process states, ProS^{P} (t₀−Δt₂, t₀), and this prediction is compared to the training or test process states, ProS^{H}(t₀−Δt₂, t₀) that were actually measured over that same period or interval. The differences between the predicted and actual historic process states for the involved interval is taken as an error term ProS^{ERROR} (t₀−Δtₜ, t₀), and is fed back into the process predictor trainer 108, which uses the error terms to improve the process model 104. This predict/feedback/update procedure is repeated until the Pros^{ERROR} falls below a defined limit or threshold, at which point the process model 104 is saved and used in the predictive control operation seen in FIG. 4.

A similar procedure is shown in FIG. 5 for the electrical predictor trainer 110. However, because the electrical model 106 will take the predicted process states from the process model 104 to make its electrical state predictions, the electrical predictor trainer 110 takes the final set of predicted process states ProS^{P} (t₀−Δt₂, t₀) from the process predictor trainer 108 as inputs to its own training process. It then operates similarly to the process predictor trainer 108, and thus also takes as its inputs, the training sets of process and electrical states ProS^{H}(t₀−Δt₁−Δt₂, t₀−Δt₂) and ElecS^{H}(t₀−Δt₁−Δt₂, t₀−Δt₂), along with a set of training or test electrical state data ElecS^{H}(t₀−Δt₂, t₀). These inputs are fed into the electrical model 106 in its initialized or starting state, to produce a set of predicted electrical states ElecS^{P} (t₀−Δt₂, t₀). The predicted electrical states ElecS^{P} (t₀−Δt₂, t₀) are then compared against the test electrical states ElecS^{H} (t₀−Δt₂, t₀) that were actually measured, and the error ElecS^{ERROR} (t₀−Δt₂, t₀) is fed back into the electrical predictor trainer 110, to improve the electrical model 106. This procedure is repeated until the error, ElecS^{ERROR} falls below a defined limit or threshold, at which point the updated electrical model 106 is saved and used in the predictive control operation seen in FIG. 4.

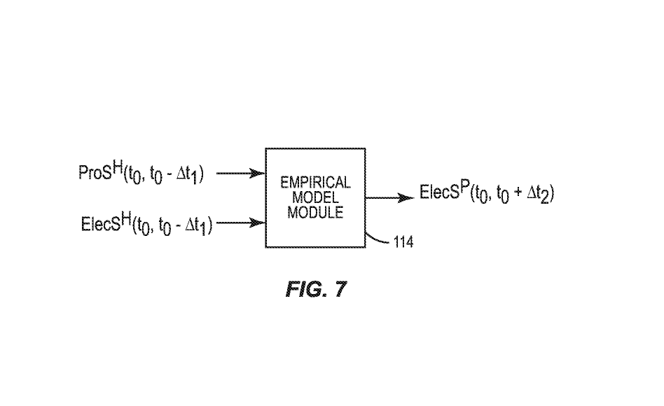

FIG. 7 depicts another method of finding the predicted electrical states and is an alternative to the methodology described above in the context of FIGS. 4-6. In the example of FIG. 7, the controller 30 implements an empirical model module 114 that builds an empirical model based on embodied engineering experience and/or previously verified mathematical relationships, such are used in expert systems. The empirical model relates historical process control information for the industrial plant 10 and corresponding historical electrical states for the electrical distribution grid 12, to predicted future electrical states of the electrical distribution grid 12. For instance, a designer may know that one ton of ore in the mill equipment 50-3 seen in FIG. 3 produces 1 MVAR of reactive power load. The controller 30 once programmed with this knowledge determines the appropriate reactive power compensation for active processing by the mill equipment 50-3 by multiplying the tons of ore in the mill equipment 50-3 by 1 MVAR.

Of course, the particular method(s) by which the controller 30 relates historical states to predicted states is subject to variability and it should be appreciated that it is broadly contemplated herein to configure a controller 30 to use historical states to predict future states, for advantageous, prediction-based reactive power compensation in the electrical distribution grid 12. Thus, FIGS. 4-6 and FIG. 7, respectively, indicate two example methods by which the desired prediction-based adjustments are obtained.

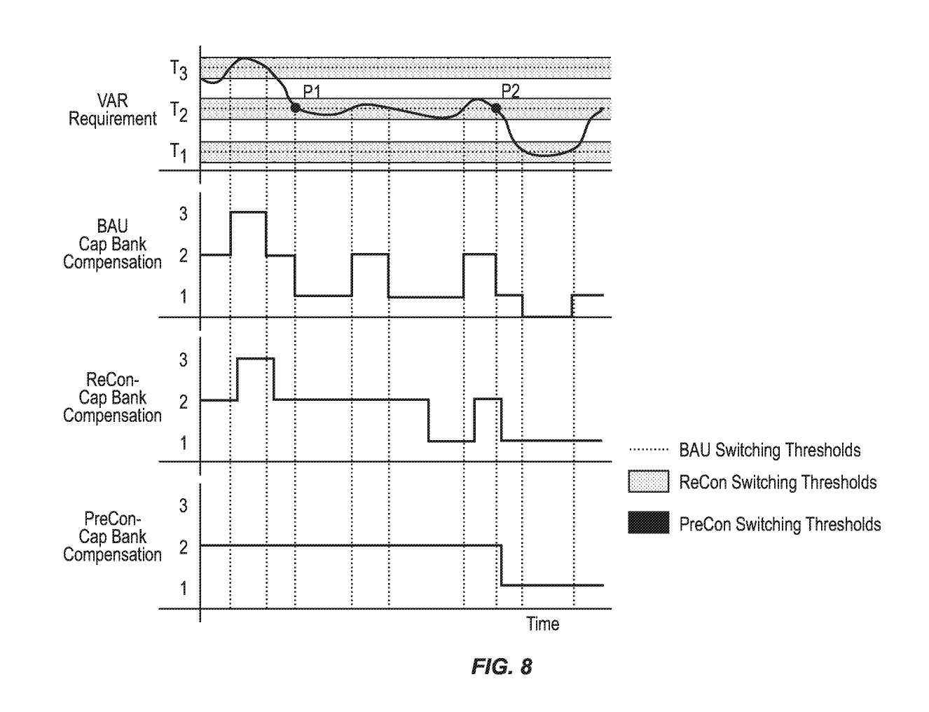

FIG. 8 illustrates another advantageous aspect of the prediction-based adjustments contemplated herein. In particular, because the controller 30 predicts electrical loading or other electrical values for the electrical distribution grid 12, based on process control information and/or historical data, the “look-ahead” predictions can be used to reduce the switching of a filter bank, e.g., such as the filter bank 54 seen in FIG. 3. Reducing the switching activity in the filter bank 54 offers a number of advantages, such as yielding a longer switch life in the filter bank 54.

In FIG. 8, the type of predictive coordinated control provided by the controller 30 is referred to as “PreCon.” In particular, one sees a filter bank switching threshold for PeCon control, as compared to switching thresholds for “ReCon” based control and Business As Usual or “BAU” based control. Here, BAU control can be understood as the type of conventional or standard filter bank switching threshold control, while ReCon denotes Reactive coordinated Control. ReCon is a reactionary rather than predictive control scheme, and it adjusts AFEs in the electrical distribution grid 12 for changes in the reactive power, where the control response comes after the such changes. In contrast, PreCon adjustments are based on predicted changes in the reactive power, with the control actions coming before or in conjunction with the predicted times. BAU merely adjusts the capacitor bank setpoints, whereas ReCon adjust the AFE setpoints. One sees that the PreCon switching threshold results in lower switching activity in filter bank 54.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A controller configured to control an electrical distribution grid used to power an industrial plant that includes one or more converters each having an active front end, AFE, that is controllable to adjust reactive power consumption by the converter, wherein the controller comprises:
a network interface configured to communicatively couple the controller to a distributed control network of the industrial plant, according to one or more network communication protocols used by the distributed control network; and
a processing circuit operatively associated with the network interface and configured to:
obtain a predicted value for an electrical parameter of the electrical distribution grid, said predicted value based on at least one of: historical data compiled for the electrical distribution grid and process control information for the industrial plant incoming to the controller from the distributed control network;
determine first reactive-power consumption adjustments for a first targeted one or more of the converters, based on evaluating the predicted value for the electrical parameter;
generate first converter control commands for the first targeted one or more of the converters, based on the first reactive-power consumption adjustments; and
transmit the first converter control commands to the first targeted one or more converters.

2. The controller of claim 1, wherein the process control information indicates a forthcoming electrical load change for the electrical distribution grid, and wherein the processing circuit is configured to obtain the predicted value of the electrical parameter based on the forthcoming electrical load change.

3. The controller of claim 2, wherein the process control information indicates the forthcoming electrical load change by indicating a forthcoming process control action for the industrial plant, and wherein the processing circuit is configured to determine the forthcoming electrical load change by accessing stored data that indicates a change in electrical load known or expected for the forthcoming process control action.

4. The controller of claim 3, wherein the processing circuit is configured to determine the first reactive-power consumption adjustments for the first targeted one or more of the converters to account for the forthcoming electrical load change, and to synchronize implementation of the first converter control commands at the first targeted one or more of the converters with a timing of the forthcoming electrical load change.

5. The controller of claim 1, wherein the process control information indicates a process control action being undertaken, or to be undertaken, in the industrial plant, and wherein the processing circuit obtains the predicted value of the electrical parameter with respect to the indicated process control action according to the historical data, which correlates previously measured values of the electrical parameter, or previously measured values related to the electrical parameter, with previously received process control information indicating a same or similar process control action.

6. The controller of claim 1, wherein the processing circuit is configured to compile the historical data by correlating previously observed changes in one or more electrical parameters of the electrical distribution grid with at least one of: process control actions in the industrial plant that are indicated to the controller via the network interface, and any one or more of time of day, day of week and calendar date.

7. The controller of claim 6, wherein the historical data indicates that a certain electrical load change is expected at a certain time, and wherein the processing circuit is configured to synchronize implementation of the first converter control commands at the first targeted one or more of the converters with the certain time.

8. The controller of claim 1, wherein the controller is further configured to perform ongoing control of the electrical distribution grid responsive to receiving measured electrical parameters for the electrical distribution grid, based on being configured to:
perform an optimization process, for ongoing optimization of the electrical distribution grid in terms of any one or more of: a total reactive power consumption of the electrical distribution grid, a voltage profile of the electrical distribution grid, and a transient voltage response of the electrical distribution grid;
wherein the controller is configured to control the optimization process based on the measured electrical parameters; and
wherein, based on the optimization process, the controller is configured to generate and send real or reactive power set points for one or more of the converters.

9. The controller of claim 1, wherein the processing circuit is further configured to perform ongoing control of the electrical distribution grid responsive to receiving measured electrical parameters for the electrical distribution grid, based on being configured to generate second converter control commands for a second targeted one or more of the converters in the electrical distribution grid, based on the measured electrical parameters, where the second converter control commands comprise one or both of reactive power set points and real power set points.

10. The controller of claim 1, wherein the processing circuit is configured to dynamically switch one or more individual ones of the one or more converters between real-power control and reactive-power control.

11. A method of controlling an electrical distribution grid used to power an industrial plant that includes one or more converters each having an active front end, AFE, that is controllable to adjust reactive power consumption by the converter, wherein the method comprises:
obtaining a predicted value for an electrical parameter of the electrical distribution grid, said predicted value based on at least one of: historical data compiled for the electrical distribution grid and process control information for the industrial plant incoming to the controller from a distributed control network;
determining first reactive-power consumption adjustments for a first targeted one or more of the converters, based on evaluating the predicted value for the electrical parameter;
generating first converter control commands for the first targeted one or more of the converters, based on the first reactive-power consumption adjustments; and
transmitting the first converter control commands to the first targeted one or more converters.

12. The method of claim 11, wherein the process control information indicates a forthcoming electrical load change for the electrical distribution grid, and wherein the method includes obtaining the predicted value of the electrical parameter based on the forthcoming electrical load change.

13. The method of claim 12, wherein the process control information indicates the forthcoming electrical load change by indicating a forthcoming process control action for the industrial plant, and wherein the method includes determining the forthcoming electrical load change by accessing stored data that indicates a change in electrical load known or expected for the forthcoming process control action.

14. The method of claim 13, wherein the method includes determining the first reactive-power consumption adjustments for the first targeted one or more of the converters to account for the forthcoming electrical load change, and to synchronize implementation of the first converter control commands at the first targeted one or more of the converters with a timing of the forthcoming electrical load change.

15. The method of claim 11, wherein the process control information indicates a process control action being undertaken, or to be undertaken, in the industrial plant, and wherein the method includes obtaining the predicted value of the electrical parameter with respect to the indicated process control action according to the historical data, which correlates previously measured values of the electrical parameter, or previously measured values related to the electrical parameter, with previously received process control information indicating a same or similar process control action.

16. The method of claim 11, wherein the method includes compiling the historical data by correlating previously observed changes in one or more electrical parameters of the electrical distribution grid with at least one of: process control actions in the industrial plant that are indicated to the controller via the network interface, and any one or more of time of day, day of week and calendar date.

17. The method of claim 16, wherein the historical data indicates that a certain electrical load change is expected at a certain time, and wherein the method includes synchronizing implementation of the first converter control commands at the first targeted one or more of the converters with the certain time.

18. The method of claim 11, wherein the method includes performing ongoing control of the electrical distribution grid responsive to receiving measured electrical parameters for the electrical distribution grid, said ongoing control comprising:
performing an optimization process, for ongoing optimization of the electrical distribution grid in terms of any one or more of: a total reactive power consumption of the electrical distribution grid, a voltage profile of the electrical distribution grid, and a transient voltage response of the electrical distribution grid;
controlling the optimization process based on the measured electrical parameters; and
generating and sending real or reactive power set points for one or more of the converters.

19. The method of claim 11, wherein the method includes performing ongoing control of the electrical distribution grid responsive to receiving measured electrical parameters for the electrical distribution grid, said ongoing control including generating second converter control commands for a second targeted one or more of the converters in the electrical distribution grid, based on the measured electrical parameters, where the second converter control commands comprise one or both of reactive power set points and real power set points.

20. The method of claim 11, wherein the method includes dynamically switching one or more individual ones of the converters between real-power control and reactive-power control.
